(19) United States
(12) Patent Application Publication
(10) Pub. No.: US 2014/0201393 A1
(43) Pub. Date: Jul. 17, 2014

(54) IMAGE PROCESSING APPARATUS AND METHOD

(71) Applicant: TOSHIBA TEC KABUSHIKI KAISHA, Tokyo (JP)

(72) Inventors: Hiromasa Suzuki, Shizuoka-ken (JP); Takahide Kubota, Shizuoka-ken (JP); Katsuhito Mochizuki, Shizuoka-ken (JP)

(73) Assignee: TOSHIBA TEC KABUSHIKI KAISHA, Tokyo (JP)

(21) Appl. No.: 14/132,376

(22) Filed: Dec. 18, 2013

(30) Foreign Application Priority Data
Jan. 16, 2013 (JP) 2013-005639

(51) Int. Cl. G06F 13/10

(52) U.S. Cl. CPC G06F 13/10
USPC 710/8

(57) ABSTRACT

An information processing apparatus comprises a connection section capable of connecting an input/output device; a communication section capable of communicating with an external apparatus; a receiving section configured to receive a request from the external apparatus through the communication section; and a control section configured to enable the input/output device connected to the connection section to execute the processing indicated by the request received by the receiving section.

### CROSS-REFERENCE TO RELATED APPLICATION

This application is based upon and claims the benefit of priority from Japanese Patent Application No. 2013-005639, filed Jan. 16, 2013, the entire contents of which are incorporated herein by reference.

### FIELD

Embodiments described herein relate to an information processing apparatus and an information processing method.

### BACKGROUND

In the past, a POS terminal such as a POS register or a personal computer POS is used in a POS system used in a store such as a supermarket. A code scanner for reading the barcode attached to a commodity, a card reader for reading information from a magnetic card and a printer are connected with relative POS terminals as input/output devices. Recently, it is proposed to use a portable information terminal such as a tablet as a cloud POS register.

### BRIEF DESCRIPTION OF THE DRAWINGS

FIG. 1 is a diagram illustrating the configuration of a POS system according to an embodiment;

FIG. 2 is a diagram schematically illustrating the external configuration of an information processing apparatus;

FIG. 3 is a diagram schematically illustrating the hardware configuration of a POS terminal;

FIG. 4 is a diagram schematically illustrating the hardware configuration of an information processing apparatus;

FIG. 5 is a diagram schematically illustrating the functional configurations of a POS terminal and an information processing apparatus;

FIG. 6 is a diagram illustrating an example of an operation screen displayed on the display of a POS terminal; and

FIG. 7 is a sequence diagram illustrating a request response processing carried out by a POS terminal and an information processing apparatus.

### DETAILED DESCRIPTION

In accordance with embodiments described herein, an information processing apparatus comprises a connection section capable of connecting an input/output device, a communication section capable of communicating with an external apparatus, a receiving section and a control section. The receiving section receives a request from the external apparatus through the communication section. The control section enables the input/output device connected to the connection section to execute a processing indicated by the request received by the receiving section.

Embodiments of the information processing apparatus and the information processing program are described below with reference to accompanying drawings. In addition, the embodiments described herein are embodiments of the information processing apparatus and the information processing program which are not presented to limit the configuration or the specification of the information processing apparatus and the information processing program. The embodiment is an example of the use of a POS system which is imported in a store such as a supermarket to carry out registration/settlement of the commodities involved in a transaction.

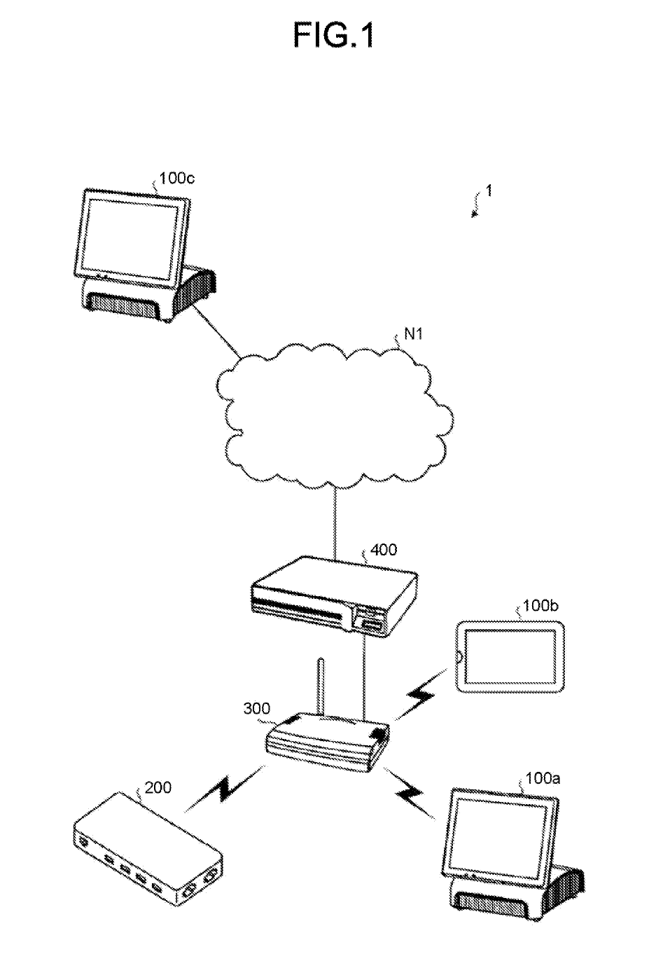

FIG. 1 is a diagram illustrating the configuration of a POS system 1 according to the embodiment. As shown in FIG. 1, the POS terminal 1 comprises POS terminals 100a, 100b and 100c and an information processing apparatus 200.

Here, the POS terminals 100a and 100b are connected with the information processing apparatus 200 in a wired or wireless communicable manner via an access point 300. Further, the POS terminal 100c existing on the Internet N1 can access the information processing apparatus 200 via a router 400 and the access point 300. The POS terminals 100a, 100b and 100c are collectively referred to as a POS terminal 100.

The POS terminal 100 is a POS register, a personal computer POS and the like. The POS terminal 100 exchanges various kinds of information with the information processing apparatus 200 via the access point 300 and the router 400.

Specifically, the POS terminal 100 sends various requests to the information processing apparatus 200. The request sent from the POS terminal 100 may be a ‘printing request’ indicating the printing output of a receipt. Further, the request sent from the POS terminal 100 may be a ‘first data acquisition request’ indicating the reading of the code data held in a code symbol such as a barcode or two-dimensional code or a ‘second data acquisition request’ indicating the reading of the card data recorded in a card such as a magnetic card or an IC card.

Preferably, the request is sent according to a general protocol such as the HTTP (Hypertext Transfer Protocol). Further, POS terminals 100a and 100c used as ordinary POS register type POS terminals in a store and a portable POS terminal 100b which is a handy terminal or a tablet terminal are presented in FIG. 1 as the POS terminal 100, however, the present invention is not limited to this case.

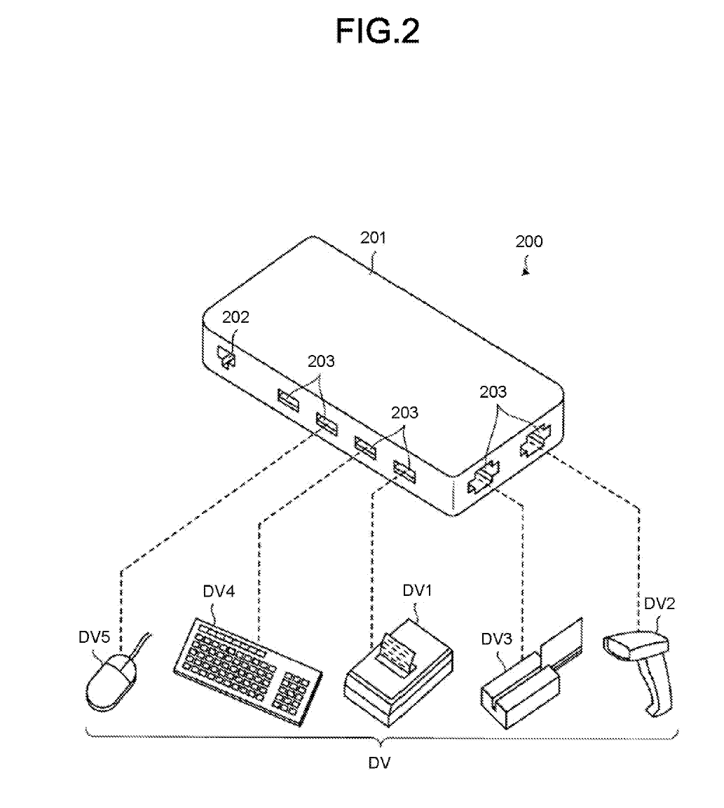

The information processing apparatus 200 is an information processing apparatus capable of connecting an input/output device and has the external configuration shown in FIG. 2. FIG. 2 is a diagram schematically illustrating the external configuration of the information processing apparatus 200. The information processing apparatus 200 has a approximately rectangular parallelepiped thin cashing 201. A communication interface 202 capable of communicating with an external device such as the access point 300 is arranged on a lateral side of the casing 201. The communication interface 202 is an LAN interface. Further, the communication interface 202 may be connected with the access point 300 when a wireless LAN interface is built-in the information processing apparatus 200 (not shown).

Further, a plurality of input/output interfaces 203 which can be detachably connected to input/output devices are arranged on a lateral side of the cashing 201. The input/output interfaces 203 are general input/output interfaces such as USB (Universal Serial Bus) or RS-232C. In the embodiment, the input/output interfaces 203 are connected with an output device such as a printer DV1 and input devices such as a code reader DV2, a card reader DV3, a keyboard DV4 and a mouse DV5 and the like. The input and output devices are described hereinafter to as input/output devices DV.

In the information processing apparatus 200 of the embodiment, the processing indicated by a request sent from the POS terminal 100 is executed by the input/output devices DV connected to the input/output interfaces 203. Further, the input/output devices DV connected with the input/output interfaces 203 may also be other devices such as displays, drawers and the like, but not limited to the example shown in FIG. 2.

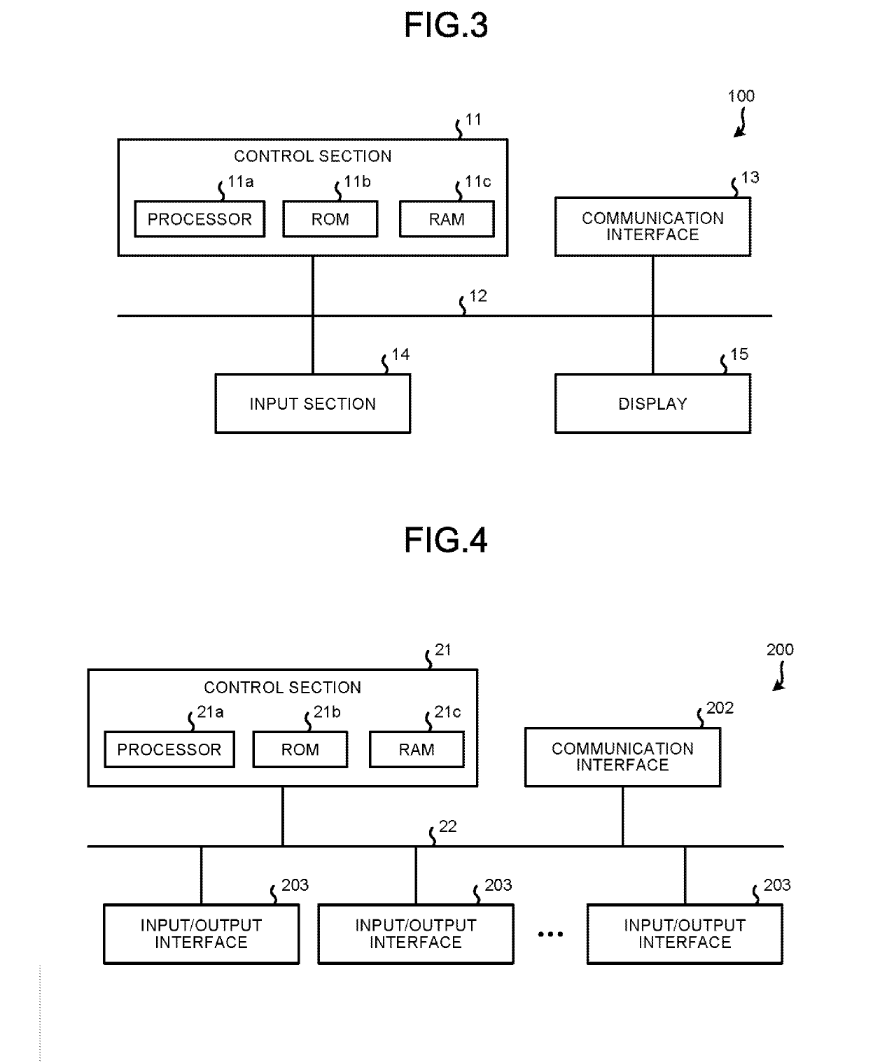

Next, hardware configurations of the POS terminal 100 and the information processing apparatus 200 are described. Here, FIG. 3 is a diagram schematically illustrating the hardware configuration of the POS terminal 100. As shown in FIG. 3, the POS terminal 100 comprises a control section 11 of a computer structure which consists of a processor 11a such as a CPU (Central Processing Unit), a ROM (Read Only Memory) 11b and a RAM (Random Access Memory) 11c. Here, the ROM 11b stores the programs executed by the processor 11a of the POS terminal 100. The RAM 11c functions as the work memory of the processor 11a.

The control section 11 is connected with the communication interface 13 which is connected via a bus 12 for wired or wireless communication. The control section 11 is constituted to execute online communication with the information processing apparatus 200 via the communication interface 13. Further, the control section 11 is connected with the input section 14 and a display 15 via the bus 12. Here, the input section 14 is an input device such as a keyboard or a touch panel.

FIG. 4 is a diagram illustrating the hardware configuration of the information processing apparatus 200. As shown in FIG. 4, the information processing apparatus 200 comprises a control section of a computer structure which consists of a processor 21a such as a CPU, a ROM 21b and a RAM 21c.

Here, the ROM 21b stores the programs executed by the processor 21a and an embedded OS. Further, the ROM 21b stores a profile representing characteristic of each input/output device DV connected to the input/output interface 203 and a device driver relating to the operations of the input/output device DV. The RAM 21c functions as the work memory of the processor 21a.

The control section 21 is connected with the communication interface 202 via a bus 22. The control section 21 is constituted to execute online communication with the POS terminal 100 via the communication interface 202. Further, the control section 21 is connected with the plurality of input/output interfaces 203 via the bus 22. By cooperating with the device driver stored in the ROM 21b, the control section 21 controls the operations of the input/output devices DV connected to the input/output interfaces 203.

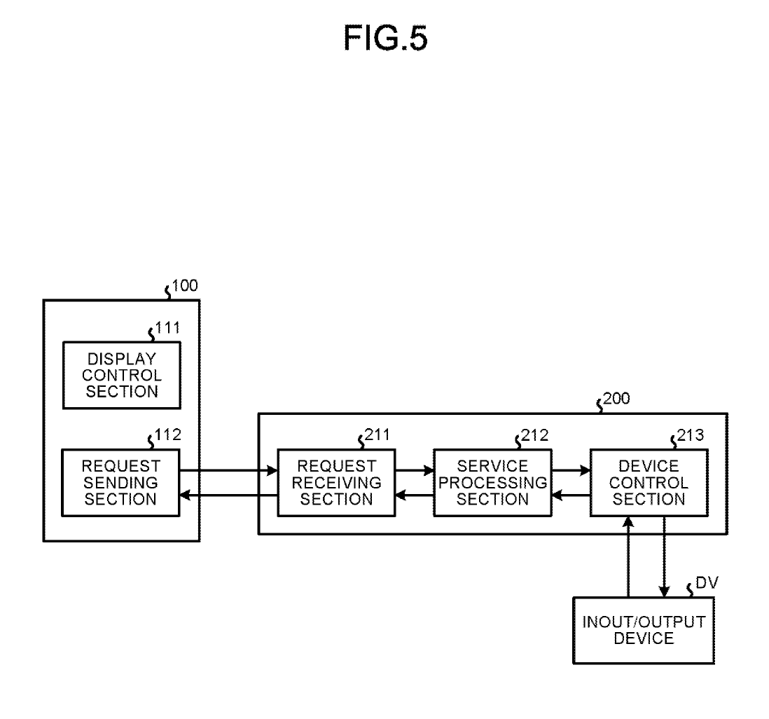

Next, the functional configurations of the POS terminal 100 and the information processing apparatus 200 are described. FIG. 5 is a diagram illustrating the functional configurations of the POS terminal 100 and the information processing apparatus 200. As shown in FIG. 5, by reading and executing the various programs stored in the ROM 11b, the processor 11a of the POS terminal 100 enables a display control section 111 and a request sending section 112 to function as function sections.

The display control section 111 enables a screen on which various kinds of information are contained to be displayed on the display 15 under the control of the control section 11. Further, by cooperating with the request sending section 112, the display control section 111 enables an operation screen relating to the request sending to the information processing apparatus 200 to be displayed on the display 15.

The request sending section 112 is a function section which sends various requests to the information processing apparatus 200. The request sending section 112 enables an operation screen relating to the request sending to be displayed on the display 15 by cooperating with the display control section 111, which is realized by a program such as a web browser.

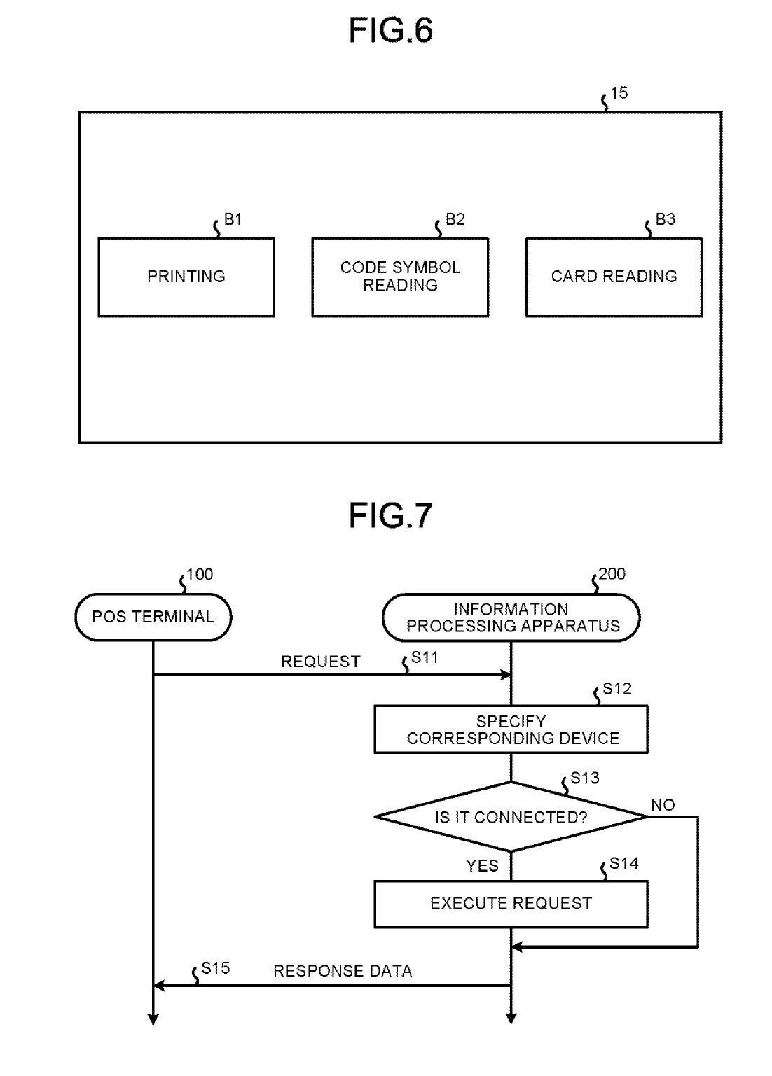

Here, FIG. 6 is a diagram illustrating an example of the operation screen displayed on the display 15 of the POS terminal 100. The diagram illustrates an operation screen for sending various aforementioned requests. In FIG. 6, the button B1 is an operator for receiving a sending instruction of a printing request. Once accepts the operation of the button B1, the request sending section 112 sends printing data to be printed and a printing request indicating the printing of the printing data to the information processing apparatus 200. Here, the printing data is data for the output of a receipt (receipt) relative to the sales registration of commodities. Further, with the operation of the button B1, a screen may be displayed to enable the printing data to be selected.

The button B2 is an operator for receiving a sending instruction of a first data acquisition request. Once accepts the operation of the button B2, the request sending section 112 sends a first data acquisition request indicating the reading of a code symbol to the information processing apparatus 200. Further, the request sending section 112 receives, from the information processing apparatus 200, the code data provided as a response data to the first data acquisition request. The code data provided from the information processing apparatus 200 is input to the control section 11 for, for example, a commodity registration.

The button B3 is an operator for receiving a sending instruction of a second data acquisition request. Once accepts the operation of the button B3, the request sending section 112 sends a second data acquisition request indicating the reading of a card to the information processing apparatus 200. Further, the request sending section 112 receives, from the information processing apparatus 200, the card data provided as a response data to the second data acquisition request. The card data provided from the information processing apparatus 200 is input to the control section 11 for, for example, a card authentication or a settlement with a credit card.

Further, a sending method of a request is not limited to which according to the operation of the buttons B1-B3. For example, in the procedure of the operations involved in a commodity settlement, a printing request for indicating the receipt output relative to the settlement may be sent automatically. Further, when displaying the error data received as response data on the display 15, the request sending section 112 carries out a notification of an error to the operator of the POS terminal 100.

Return to FIG. 5, by reading and executing various programs stored in the ROM 21b, the processor 21a of the information processing apparatus 200 enables a request receiving section 211, a service processing section 212 and a device control section 113 to function as function sections.

The request receiving section 211 receives the request sent from the POS terminal 100 via the communication interface 202. Further, the request receiving section 211 provides (sends) the response data corresponding to the received request for the POS terminal 100 sending the request through the cooperation of the service processing section 212 and the device control section 213.

The service processing section 212 analyzes the processing content indicated by the request received by the request receiving section 211 and specifies an input/output DV (referred hereinafter to as a corresponding device) corresponding to the processing. More specifically, the service processing section 212 specifies an input/output device DV capable of executing the processing indicated by the request as a corresponding device based on the profile of each input/output device DV stored in a not shown ROM.

For example, the service processing section 212 specifies the printer DV1 as the corresponding device when the request receiving section 211 receives a printing request. Further, the service processing section 212 specifies the code reader DV2 as the corresponding device when the request receiving section 211 receives a first data acquisition request. Further, the service processing section 212 specifies the card reader DV3 as the corresponding device when the request receiving section 211 receives a second data acquisition request.

Further, once acquires the response data to a request from the device control section 213, the service processing section 212 outputs the response data to the request receiving section 211. Further, the request receiving section 211 and the service processing section 212 may also be achieved by a program such as a web server or a web application.

The device control section 213 activates the corresponding device specified by the service processing section 212 to enable the corresponding device to execute the processing indicated by the request. More specifically, by cooperating with the device driver of the corresponding device, the device control section 213 enables the corresponding device to execute the processing indicated by the request. Further, the device control section 213 outputs the processing result according to the corresponding device to the service processing section 212 as response data to the request.

For example, when the printer DV 1 is specified as the corresponding device according to a printing request, the device control section 213 makes the printing data contained in the printing request printed and outputted from the printer DV 1 connected with the input/output interface 203, moreover, when the printing output of the printer DV1 is completed, the device control section 213 outputs response data representing the completion of the printing output to the service processing section 212.

Further, if the code reader DV2 is specified as the corresponding device according to a first data acquisition request, the device control section 213 activates the code reader DV2 connected with the input/output interface 203 to read code data. Furthermore, once the reading of the code data is carried out by the code reader DV2, the device control section 213 outputs the code data to the service processing section 212 as response data.

Further, if the card reader DV3 is specified as the corresponding device according to a second data acquisition request, the device control section 213 activates the card reader DV3 connected with the input/output interface 203 to read card data. Afterwards, once the reading of the card data is carried out by the card reader DV3, the device control section 213 outputs the card data to the service processing section 212 as response data.

Further, when activating the corresponding device, the input/output interface 203 determines whether or not the corresponding device is actually connected to the input/output interface 203. If it is determined that the corresponding device is actually connected, the input/output interface 203 uses the corresponding device to execute the processing indicated by the request. Further, if it is determined that the corresponding device is not actually connected, the input/output interface 203 outputs error data representing that the request cannot be processed as response data to the service processing section 212.

Further, the determination method on whether or not the corresponding device is connected is not limited, and it may also use a known or public technology. Further, the connection determination of the corresponding device is carried out by the device control section 213 in the embodiment, however, the present invention is not limited to this, and the connection determination may also be carried out by the service processing section 212, the control section 21 or an operating system level.

Next, the operations of the information processing apparatus 200 are described with reference to FIG. 7. FIG. 7 is a sequence diagram illustrating a response processing for a request carried out by the POS terminal 100 and the information processing apparatus 200.

First, in the POS terminal 100, once receives an operation indicating the request sending, the request sending section 112 sends a request corresponding to the content of the operation to the information processing apparatus 200 (ACT S11).

On the other hand, in the information processing apparatus 200, the request receiving section 211 receives the request sent from the POS terminal 100. The service processing section 212 specifies a corresponding device based on the instruction content of a request received by the request receiving section 211 (ACT S12). Next, the device control section 213 determines whether or not the corresponding device specified in ACT S12 is connected to the input/output interface 203 (ACT S13).

If it is determined in ACT S13 that the corresponding device is not connected (NO in ACT S13) , the device control section 213 sends error data representing which the request cannot be processed to the POS terminal 100 as response data (ACT S15).

Further, if it is determined in ACT S13 that the corresponding device is connected (YES in ACT S13), the device control section 213 enables the corresponding device to execute the processing relating to the request (ACT S14). Then, the information processing apparatus 200 sends the processing result in the corresponding device to the POS terminal 100 as response data (ACT S15).

Then, the request sending section 112 of the POS terminal 100 receives the response data provided from the information processing apparatus 200.

As stated above, in the embodiment, the information processing apparatus 200 receives the request sent from each POS terminal 100 and processes the request using the input/output device DV connected to self-device. In this way, the input/output device DV connected to the information processing apparatus 200 can be shared by a plurality of POS terminals 100, thereby improving convenience on the usage of the input/output device DV.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, the programs executed by the POS terminal 100 and the information processing apparatus 200 in the aforementioned embodiment are embedded in the ROMs 11b and 21b in advance, however, the present invention is not limited to this case, the programs may also be embedded in a readable-writable non-volatile storage medium such as an HDD (Hard Disk Drive) or a SSD (Solid State Drive). Further, the programs executed by the POS terminal 100 and the information processing apparatus 200 in the aforementioned embodiment may also be recorded in a computer-readable recording medium such as a CD-ROM a flexible disk (FD), a CD-R, a DVD (Digital Versatile Disk) in an installable or executable form.

Further, the programs executed by the POS terminal 100 and the information processing apparatus 200 in the aforementioned embodiment may also be stored in a computer connected to a network such as the Internet and then downloaded from the network. Further, the programs executed by the POS terminal 100 and the information processing apparatus 200 in the aforementioned embodiment may also be provided or distributed via a network such as the Internet.

The programs executed by the POS terminal 100 and the information processing apparatus 200 in the aforementioned embodiment become a module configuration including each aforementioned part. As actual hardware, programs are read from the ROM and then executed by a processor, and each aforementioned part is downloaded to a primary storage apparatus and generated on the primary storage apparatus.

What is claimed is:

1. An information processing apparatus, comprising:
a connection section capable of connecting an input/output device;
a communication section capable of communicating with an external apparatus;
a receiving section configured to receive a request from the external apparatus through the communication section; and
a control section configured to enable the input/output device connected to the connection section to execute the processing indicated by the request received by the receiving section.

2. The information processing apparatus according to claim 1, further comprising:
a specifying section configured to specify an input/output device corresponding to the processing indicated by the request; wherein
the control section enables the input/output device specified by the specifying section to execute the processing indicated by the request.

3. The information processing apparatus according to claim 2, wherein
If the request indicates the reading of data, the specifying section specifies an input device included in the input/output device, and
the control section enables the input device specified by the specifying section to carry out the reading of the data.

4. The information processing apparatus according to claim 2, wherein
if the request indicates the output of data, the specifying section specifies an output device included in the input/output device, and
the control section enables the output device specified by the specifying section to carry out the output of the data.

5. The information processing apparatus according to claim 2, further comprising:
a determination section configured to determine whether or not the input/output device specified by the specifying section is connected to the connection section; and
a response section configured to feedback error to the external apparatus sending the request if the determination section determines that the input/output section is not connected.

6. A method for enabling a computer of an information processing apparatus provided with a connection section capable of connecting an input/output device and a communication section capable of communicating with an external apparatus and a receiving section capable of receiving a request from the external apparatus and, comprising:
receiving a request from the external apparatus through the communication section; and
controlling the input/output device connected to the connection section to execute the processing indicated by the received request.
